(19) United States
(12) Patent Application Publication
(10) Pub. No.: US 2010/0013362 A1
(43) Pub. Date: Jan. 21, 2010

(54) CORD ORGANIZING APPARATUS FOR AN IMAGE DISPLAY DEVICE

(75) Inventors: Danny Han, Happy Valley, OR (US); Chris Valentine, Portland, OR (US); Robert David Woolf, Lake Oswego, OR (US); Ross Kruse, Salem, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: INFOCUS CORPORATION, Wilsonville, OR (US)

(21) Appl. No.: 12/505,261

(22) Filed: Jul. 17, 2009

Related U.S. Application Data
(60) Provisional application No. 61/082,077, filed on Jul. 18, 2008.

(51) Int. Cl. F16L 3/02; A47B 81/00

(52) U.S. Cl. 312/223.1; 24/115 R

(57) ABSTRACT

An image display device is provided with a cord organizing apparatus. The image display device includes a housing enclosing electronic componentry, a plurality of analog, digital, or power cords coupled to and extending from the electronic componentry, and a cord organizing apparatus coupled to the housing. The cord organizing apparatus includes a plurality of teeth and at least a first tooth opening and a second tooth opening sized to removably retain the cords.

### CROSS-REFERENCE TO RELATED APPLICATIONS

This application claims priority from U.S. Provisional Patent Application No. 61/082,077, entitled “CORD ORGANIZING APPARATUS FOR A PROJECTION DEVICE,” filed Jul. 18, 2008, the disclosure of which is hereby incorporated by reference in its entirety and for all purposes.

### FIELD

The present application relates to systems and apparatus for arranging cords in an image display device.

### BACKGROUND

Image display devices may be used in a variety of environments. For example, information image display devices, including, but not limited to televisions, monitors, and projectors may be adapted to display images, including text, graphics, video images, still images, presentations, etc. Such image devices may be found in home environments and applications, education environment and applications, business facilities, conference rooms and other meeting facilities, etc. The following is a non-exhaustive list of exemplary image devices: cathode ray tubes (CRTs), projectors, flat panel liquid crystal displays (LCDs) systems, light emitting diode (LED) systems, plasma systems, front projection systems, rear projection systems, LCD monitors, etc. Large format display devices may include but are not limited to televisions, front-projection systems, and rear-projections systems.

The images or content displayed on the image display devices may be provided by a plurality of different content sources. For example, content may be provided by content sources or remote computing devices, including, but not limited to, computers, laptop computers, personal computers, storage mediums, such as memory cards and other memory devices, cameras, telephones, smartphones, portable data assistants, etc. Image data from the content source may be transmitted to the display device directly or through a network. The content source may be connected, e.g. wired or wirelessly, to the image device for display of the content.

Typically, image display devices include a number of cords extending out of the housing of the device. Exemplary cords may include, power input, audio input, video input, etc. Proper coupling of the cords to various devices and outlets may be needed for the image display device to properly function.

When setting up an image display device it may be difficult to organize the cords in a comprehensible fashion. Unorganized cords may lead to incorrect cord attachment, wasting valuable time and increasing the frustration of the user of the image display device.

The inventors herein have recognized that cords extending out of the projection device may need to be organized in a logical manner, allowing an operator of the image display device to quickly and correctly set up the image display device.

### SUMMARY

An image display device is provided with a cord organizing apparatus. The image display device includes a housing enclosing electronic componentry, a plurality of analog, digital, or power cords coupled to and extending from the electronic componentry, and a cord organizing apparatus coupled to the housing. The cord organizing apparatus includes a plurality of teeth and at least a first tooth opening and a second tooth opening sized to removably retain the cords.

### BRIEF DESCRIPTION OF THE FIGURES

FIG. 1 shows a schematic depiction of an image display device including a cord organizing apparatus.

FIG. 2 shows an isometric view of a first embodiment of display device with a cord organizing apparatus.

FIG. 3 shows a detailed view of the cord organizing apparatus shown in FIG. 2.

FIG. 4 shows an isometric view of a second embodiment of a cord organizing apparatus included in an image display device.

FIG. 5 shows a detailed view of the cord organizing apparatus shown in FIG. 4.

FIG. 6 shows another embodiment of a cord organizing apparatus.

### DETAILED DESCRIPTION

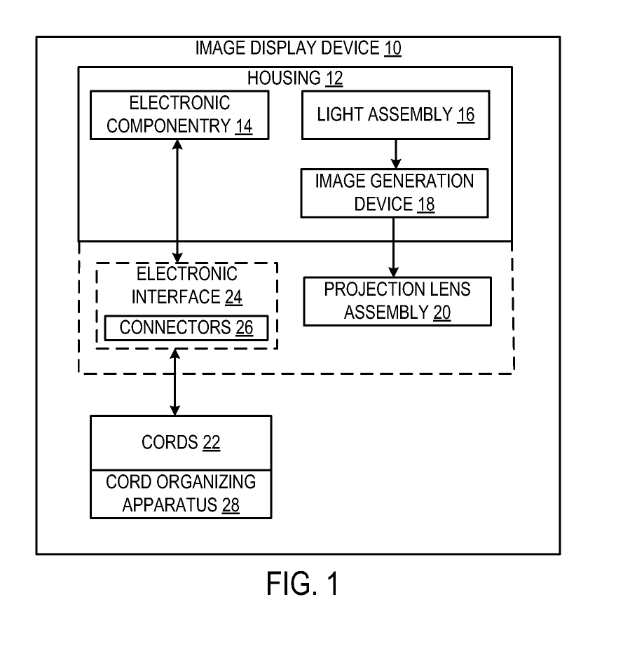

FIG. 1 schematically illustrates an image display device 10. As described and illustrated herein, image display devices may be a projection device, such as a front projection device. In some examples, the projection device may be configured to be vertically mounted onto a ceiling or overhang. Yet in other examples, the projection device may be configured to be positioned onto a surface such as a table, chair, etc. However, it should be appreciated that the image display device may be other types of display devices, including, but not limited to front projection systems, rear-projection systems, etc. In other embodiments, the image display device may be an LCD system, a laser system, a large format display device, etc. Furthermore, image display device 10 may be another suitable electronic device including electronic componentry and cords extending there from.

Image display device 10 may include housing 12 enclosing various components, such as electronic componentry 14, light assembly 16, and image generation device 18 configured to generate an image for display or projection. Light assembly 16 may include one or more light sources, such as LEDs, linked to image generation device 18. Light may be directed from the light assembly through the image generation device, and then through at least a projection lens assembly 20 to a display surface, such as a screen. Projection lens assembly 20 may include at least one projection lens. In this embodiment, the projection lens assembly is not enclosed in the housing. However, it will be appreciated that in other embodiments the projection lens assembly may be fully or partially enclosed within the housing. Further in other embodiments, other suitable components may be utilized to generate an image in the image display device.

Electronic componentry 14 may be coupled to a plurality of cords 22. However, in other examples the electronic componentry may be coupled to a single cord. The cords may be analog, digital, and/or power cords, such as an audio, video or power connections (e.g. inputs or outputs), allowing the image display device to connected to external devices, such as a computer, an additional image display device, a power source (e.g. wall outlet), etc. It will be appreciated that an analog, digital, or power cord may include a flexible housing surrounding one or more wires.

The analog cords may include at least one analog connector (e.g. plug and/or socket), such as a phono connector (e.g. RCA connector), an ⅛^{th} inch tip, ring, sleeve (TSR) connector, a ¼ inch TSR connectors, etc., in some examples. The digital cords may include at least one digital connector, such as a Universal Serial Bus (USB) connector, a serial or parallel port connector, etc., in some examples. Additionally, the power cords may include at least one connector, such as a two or three prong 110 volt alternating current (A/C) plug or socket, in some examples.

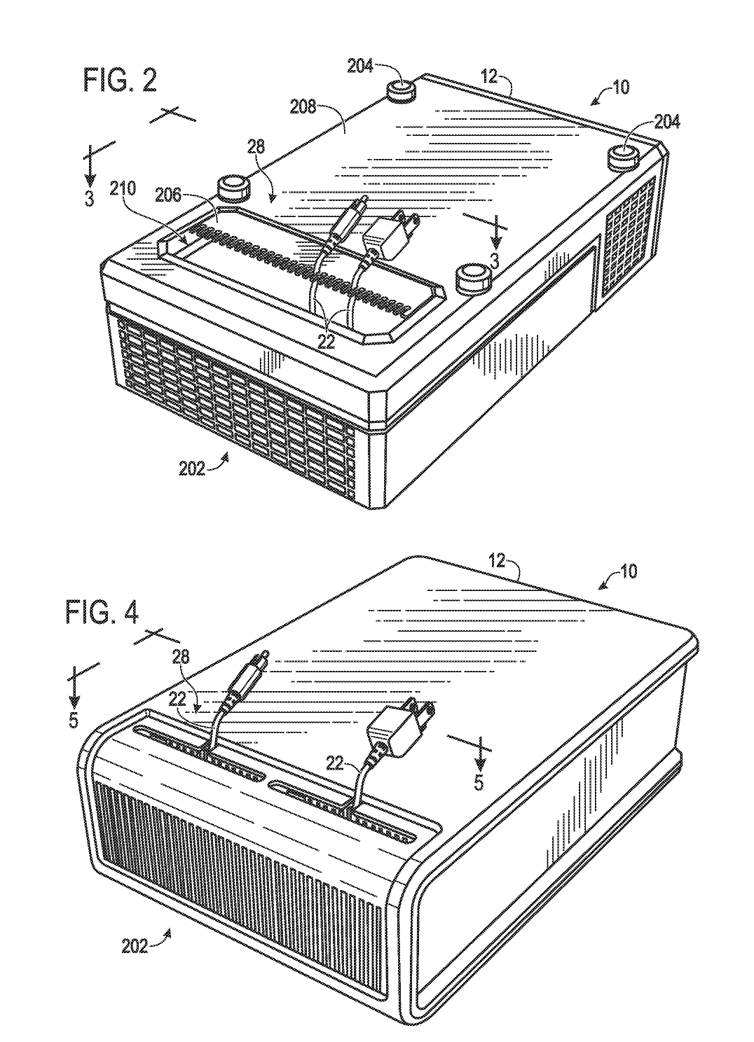

The cords may be coupled to the electronic componentry via an electronic interface 24, in some embodiments. Electronic interface 24 may include a plurality of connectors 26. In this way, cords 22 may be removed from the image display device, preventing the cords from becoming an impediment during transportation or adjustment of the image display device. The connectors may be analog connectors, digital connectors, and/or power connectors. Exemplary connectors are described above. It will be appreciated that in other embodiments the cords may be directly coupled to the electronic components. The cords may be removably retained via a cord organizing apparatus 28, discussed in greater deal herein with regard to FIGS. 2-6.

FIG. 2 illustrates a first exemplary embodiment of image display device 10. As previously discussed the image display device may include housing 12 enclosing various components Further illustrated in FIG. 2, is a venting panel 202 allowing external air to circulate within the image display device, cooling the electronic componentry and decreasing the chance of failure due to overheating.

Further, protrusions 204 may be included in the housing. As shown, protrusions 204, such as cylindrical protrusions, may support the device when it is positioned on a surface, such as a table. The protrusions may increase the stability of the image display device as well as prevent the cords from becoming wedged underneath the device. Alternatively, the image display device may be semi-permanently mounted on a ceiling, wall, etc., via a mounting plate and/or hardware. Therefore, when the image display device is mounted on a ceiling, wall, etc., the protrusions or other devices may act as spacers. It may be particularly difficult to arrange the cords and attach the cords to an external device while mounting the image display device on the ceiling. The cord organizing apparatus allows a user to removably attach the cords to the cord organizing apparatus in a desired arrangement, allowing the cords to be easily coupled to an external device, thereby decreasing the difficulty of mounting the image display device. It will be appreciated that in other embodiments, the venting panel and/or protrusions may not be included in image display device 10.

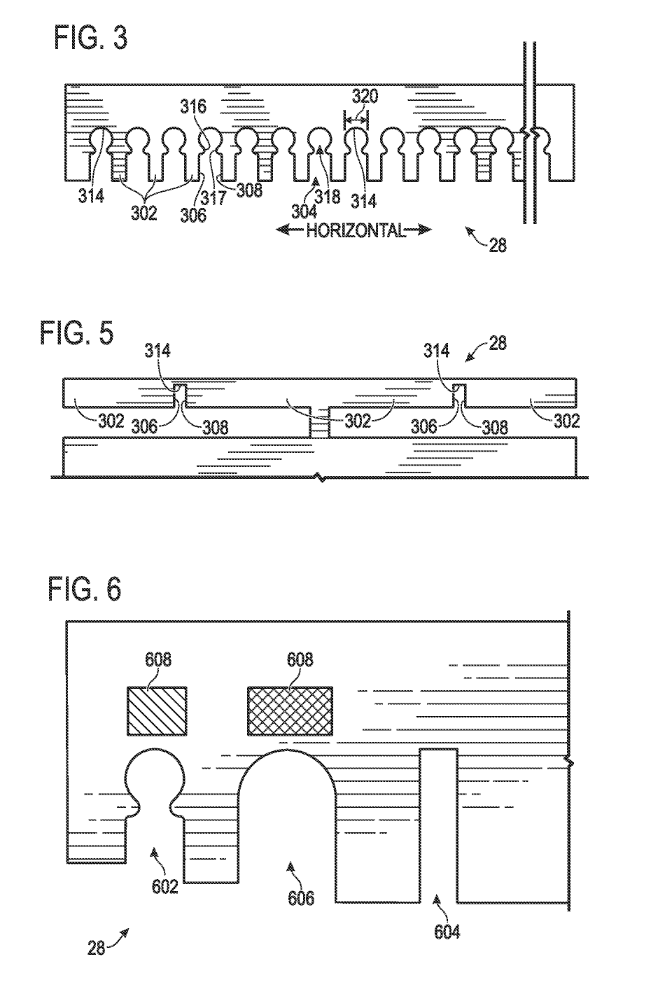

The cord organizing apparatus is shown coupled to housing 12. In some embodiments, the cord organizing apparatus may be coupled to the housing via suitable attachments mechanisms such as bolts, screws, clasps, snaps, etc. In this way, the cord organizing apparatus may be secured to the housing. Further, as depicted in FIG. 3, the cord organizing apparatus may be integrally molded with the housing. Further still in other embodiments, the cord organizing apparatus may be hingedly connected to the housing. A hinged cord organizing apparatus may be configured to enable a user to open the cord organizing apparatus to enable a user to plug the cords into the receiving outlets or connectors. The user may the position the cord such that it crosses over to a desired exit position. In some example, any additional cord, such as unused cord length, may be stored in the opening and retained when the cord organizing apparatus is closed into operation or mounting position.

It can be appreciated that the cord organizing apparatus may be positioned such that the cords are substantially fixed as they exit the image display device, preventing unwanted bending, twisting, removal, release, knotting, etc. of the cords. Further, the cord organizing apparatus may cover an opening which may be of sufficient size to retain extra cord length or to reduce the unused cord length extending out from the device. The opening may be of sufficient size to enable access to the connectors and to enable the cords to be easily coupled to the connectors. Depending on the depth of the opening the opening in combination with the cord organizing apparatus may secure the cords and prevent accidental release of the cords from the connectors.

As depicted in FIG. 2, a body 206 of cord organizing apparatus 28 is aligned with a surface 208 of the housing. However, it will be appreciated that alternate configurations are possible. For example, the body of the cord organizing apparatus may be arranged at an angle with respect to surface 208 or alternatively the cord organizing apparatus may be positioned on another side of image display device 10. Furthermore, the cord organizing apparatus may be positioned within an opening 210 in housing 12, facilitating access to the cords 22 and enabling a user to selectively connect and disconnect the cords from the image display device.

Cord organizing apparatus 28 may be configured to removably retain the cords 22 extending from image display device 10. The cords may be secured and unsecured via a user, allowing the user to organize the cords. Thus, cords 22 may be removably retained by the cord organizing apparatus 28. The user may thus customize the cord arrangement and exit pattern of the cords.

FIG. 3 shows a detailed view of cord organizing apparatus 28 illustrated in FIG. 3. The cord organizing apparatus may include a plurality of teeth 302 and teeth openings 304. Each tooth opening may be defined by a first and a second surface, 306 and 308. In this embodiment, at least a portion of the first surface and a portion of the second surface may be parallel. However in other embodiments, the first and the second surfaces may be parallel or alternatively may be tapered.

An adjoining surface 314 may connect the first surface 306 to the second surface 308. The adjoining surface may be curved in a concave manner, thereby increasing contacted surface area between a cylindrical cable and the teeth.

A first protrusion 316 may extend from the first surface toward the second surface. Likewise, a second protrusion 317 may extend from the second surface toward the first surface. Protrusions 316 and 317 may be curved to prevent the cords from being damaged. Additionally, the protrusion may be sized such that the cord may compress when the cord is shifted into place by the user. In this way, the cords may be secured in a receiving region 318 of the tooth opening, preventing unwanted movement of the cord. Moreover, the protrusion may be sized to prevent damage to the internal wires included in the cord.

In some examples, the width 320 of the adjoining surface 314 may be less than or equal to the horizontal distance between the first surface 306 and the second surface 308, allowing the cord to be easily placed within a tooth opening. However, in other examples, the width of the adjoining surface may be greater than the horizontal distance between the first and second surfaces.

A second exemplary embodiment of image display device 10 and associated cord organizing apparatus 28 is shown in FIGS. 4 and 5. Similar components are labeled accordingly. As illustrated the cord organizing apparatus 28 has a different configuration. In particular, the number of teeth opening included in the cord organizing is adjusted. Additionally, adjoining surface 314 is flat and therefore perpendicular to the first surface 306 as well as the second surface 308. Furthermore, the cord organizing apparatus is integrally molded with the housing. It will be appreciated that numerous configuration are possible and the embodiment depicted in FIGS. 4 and 5 is exemplary in nature.

It will be appreciated that the size, geometry, and or characteristics of one or more teeth openings may be adjusted in other embodiments. For example, as depicted in FIG. 6 a tooth opening 604 may be included in the cord organizing apparatus that does not include protrusions, allowing the cord to be easily attached and detached from the cord organizing apparatus. However, the cord organizing apparatus may include one or more tooth opening 602 with protrusions. Moreover, the width of a tooth opening 602 may be different than the width of a second tooth opening 606 and a third tooth opening 604. In this way different type of cords having varying widths may be attached to the cord organizing apparatus. Further, the horizontal spacing between teeth openings 602 and 606 may be different from the horizontal spacing between teeth opening 606 and 604. Still further in other examples, the depth of the teeth openings may be adjusted. That is to say that a portion of the teeth opening may be more recessed into the body of the cord organizing apparatus than other teeth openings. It will be appreciated in alternate embodiments that other adjustments to the size, geometry, and/or configuration may be implemented. That is to say that alternate combinations of teeth openings having different configurations are possible.

Furthermore, sections 608 of the cord organizing apparatus, which may be adjacent to the tooth openings, may be different in appearance allowing the operator of the projection device to discern the proper cord placement in the cord organizing apparatus, allowing a user to quickly and intuitively set up the image display device. For example, section 608 may have a different size, color, texture, geometry, and/or indicia. Thus, in some example, the tooth openings and/or teeth may be sized to receive a specific type of cord. In other systems, the tooth opening and/or teeth may be textured or have a specific geometry to retain a specific type of cord or bundle of cords. In other examples, indicia, colors, etc. may assist in user in identifying positions for arranging the cords for easy mounting or use. It will be appreciated that numerous configurations of the cord organizing apparatus are possible and the embodiment depicted in FIG. 6 is exemplary in nature.

The image display device and cord organizing apparatus described above allows a user to removably attach and detach a plurality of cords as well as enable arrangement of the cords for easy use and/or mounting. For example, during or prior to set up of an image display device, the user may select to arrange the cords to enable the cords to exit the image display device toward another external device, such as a computer, additional image display devices, power sources (e.g. wall outlet), etc., or to any other selected position or device. Specific cords may be bundled or grouped together to enable ease of mounting. For example, when mounting the image display device on a ceiling mount, the ease of pre-positioning and arranging the cords such that the cords exit the image display device in a structured and ordered manner may reduce user frustration and enable easy installation. The ability for a user to customize the cord arrangement through use of the cord organizing apparatus prevents the cords from having to cross over the device or wrap around the device in a jumbled or disorderly fashion. As such the cord organizing apparatus enables a user to quickly and efficiently set up an image display device without unwanted bending, twisting, removal, release, knotting, etc. of the cords extending from the image display device.

Although the present disclosure includes specific embodiments, specific embodiments are not to be considered in a limiting sense, because numerous variations are possible. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring, nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An image display device comprising:
a housing enclosing electronic componentry;
a plurality of analog, digital, or power cords removably coupled to and extending from the electronic componentry; and
a cord organizing apparatus coupled to the housing, the cord organizing apparatus including a plurality of teeth and at least a first tooth opening and a second tooth opening sized to removably retain the cords.

2. The image display device of claim 1, wherein the first tooth opening is different in size and/or geometry than the second tooth opening.

3. The image display device of claim 1, wherein each tooth opening is defined by a first and a second surface and at least a portion of the first surface is parallel to at least a portion of the second surface.

4. The image display device of claim 3, wherein at least a portion of the first surface and/or the second surface includes a protrusion extending toward the adjacent surface, the protrusion sized to secure a cord included in the plurality of cords.

5. The image display device of claim 1, wherein the cord organizing apparatus is integrally molded into the housing of the electronic device.

6. The image display device of claim 1, wherein the cord organizing apparatus is hingedly connected to the housing.

7. The image display device of claim 1, wherein the cords are coupled to the electronic componentry via an electronic interface configured to enable detachment and attachment of the cords from the electronic device.

8. The image display device of claim 1, wherein a first section of the cord organizing apparatus proximate to the first tooth opening is different in appearance from a second section of the cord organizing apparatus proximate to the second tooth opening.

9. The image display device of claim 1, wherein the analog cords includes at least one phono connector and/or tip, ring, sleeve connector and the digital cords includes at least one universal serial bus connector and/or port connector.

10. An image display device for generation and projection of an image, the image display device comprising:
a housing enclosing a light assembly, an image generation device, and electronic componentry configured to generate an image for projection;
a plurality of removable analog, digital, or power cords coupled to and extending from the electronic componentry; and
a cord organizing apparatus for selectively customizing a cord arrangement, the cord organizing apparatus having two or more teeth and at least a first tooth opening sized to removably retain at least one analog, digital, or power cords;
wherein the tooth opening is defined by a first surface and a second surface and at least a portion of the first surface and second surface are substantially parallel.

11. The image display device of claim 10, further comprising a second tooth opening defined by a third and a fourth surface, wherein the first opening is further defined by a first adjoining surface and the second opening is defined by a second adjoining surface.

12. The image display device of claim 11, wherein the first adjoining surface is curved.

13. The image display device of claim 11, wherein the first adjoining surface is perpendicular to one of the first surface.

14. The image display device of claim 10, wherein at least a portion of the teeth include protrusions extending towards an adjacent surface configured to secure the removable cords.

15. The image display device of claim 10, wherein the cords includes one or more wires surrounded by a flexible housing.

16. The image display device of claim 10, wherein the cords are configured to provide an image, audio, and/or power connection to at least one external device.

17. The image display device of claim 10, wherein the removable cords are coupled to the electronic componentry via an electronic interface configured to allow attachment and detachment of the removable cords from the image display device.

18. A cord organizing apparatus for arranging cords from a projection device, the cord organizing apparatus comprising:
a body;
a plurality of teeth and teeth openings, each tooth opening sized to removably retain a detachable cord, at least a portion of the teeth include a protrusion extending towards an adjacent tooth configured to secure a removable cord;
wherein the teeth openings are each defined by a first and second surface and at least a portion each of the first and second surfaces are substantially parallel.

19. The cord organizing apparatus of claim 18, wherein the body is hingedly connected to the projection device.

20. The cord organizing apparatus of claim 18, wherein at least one tooth is a different size than a second tooth.
